(19) United States
(12) Patent Application Publication
(10) Pub. No.: US 2021/0019323 A1
(43) Pub. Date: Jan. 21, 2021

(54) INFORMATION PROCESSING APPARATUS, DATA MANAGEMENT SYSTEM, DATA MANAGEMENT METHOD, AND NON-TEMPORARY COMPUTER READABLE MEDIUM INCLUDING DATA MANAGEMENT PROGRAM

(71) Applicant: NEC CORPORATION, Tokyo (JP)

(72) Inventor: Toru WAKITANI, Tokyo (JP)

(73) Assignee: NEC CORPORATION, Tokyo (JP)

(21) Appl. No.: 17/043,290

(22) PCT Filed: Sep. 6, 2018
(86) PCT No.: PCT/JP2018/032969

§ 371 Date: Sep. 29, 2020

(30) Foreign Application Priority Data
Mar. 30, 2018 (JP) 2018-067081

(51) Int. Cl. G06F 16/25; G06F 16/2457; G06F 16/23

(52) U.S. Cl. CPC G06F 16/252; G06F 16/2308; G06F 16/24573

(57) ABSTRACT

Data in files for a plurality of different purposes are uniformly managed. An information processing apparatus (1) includes an extraction unit (11) configured to extract a pair of an attribute (1412) and data (1411) based on a format corresponding to each collection file from a plurality of collection files collected from an information system and described in a plurality of respective types of the formats, a first specifying unit (12) configured to specify position information (1413) indicating a position in the collection file corresponding to the extracted data (1411), and a registration unit (13) configured register a management record (141) in a database (14), in which the management record (141) includes the attribute (1412) corresponding to the extracted data (1411), the specified position information (1413), and file identification information (1414) of the collection file associated with the extracted data (1411).

### TECHNICAL FIELD

The present disclosure relates to an information processing apparatus, a data management system, a data management method, and a data management program. In particular, the present disclosure relates to an information processing apparatus, a data management system, a data management method, and a data management program for managing data in files for a plurality of different purposes.

### BACKGROUND ART

Recently, as information systems become larger and more complex, the types of data to be collected from the information systems have become diversified. The data format differs depending on the information system from which the data is collected. In order to address this issue, Patent Literature 1 to 3 disclose a technique for converting log data into a common format.

Patent Literature 1 discloses a technique for collecting log information from various servers, converting the collected log information into a data set serving as input data when statistical processing is performed, performing statistical processing, and storing a result of the statistical processing in a display format. Patent Literature 2 discloses a technique related to a log format conversion apparatus for automatically generating a log format necessary for converting various log files into a common format. The log format conversion apparatus described in Patent Literature 2 extracts regularity from knowledge for log format generation and a character string pattern of a log to automatically generate a log format. Patent Literature 3 discloses a technique for converting a plurality of types of formats of log messages to generate a common format of the log messages.

### CITATION LIST

### Patent Literature

Patent Literature 1: Japanese Unexamined Patent Application Publication No. 10-312323
Patent Literature 2: Japanese Unexamined Patent Application Publication No. 2007-249694
Patent Literature 3: Japanese Unexamined Patent Application Publication No. 2009-009448

### SUMMARY OF INVENTION

### Technical Problem

However, Patent Literature 1 to 3 have a problem that data in files for a plurality of different purposes cannot be uniformly managed. The reason for this is that although Patent Literature 1 to 3 generate a common format of log files, which are files for a specific purpose, the log files for different purposes are not suitable for a common format, because the quality of records and attributes differ depending on the file.

The present disclosure has been made to solve such a problem. An object of the present disclosure is to provide an information processing apparatus, a data management system, a data management method, and a data management program for uniformly managing data in files for a plurality of different purposes.

### Solution to Problem

A first example aspect of the present disclosure is an information processing apparatus including:

an extraction unit configured to extract a pair of an attribute and data based on a format corresponding to each collection file from a plurality of collection files collected from an information system and described in a plurality of respective types of the formats;

a first specifying unit configured to specify position information indicating a position in the collection file corresponding to the extracted data; and

a registration unit configured register a management record in a database, the management record including the attribute corresponding to the extracted data, the specified position information, and file identification information about the collection file associated with the extracted data.

A second example aspect of the present disclosure is a data management system including:

a collection unit configured to collect a plurality of collection files described in a plurality of respective types of formats from an information system and store the plurality of collection files in a storage apparatus;

an extraction unit configured to extract a pair of an attribute and data based on the format corresponding to each collection file from the plurality of collection files in the storage apparatus;

a first specifying unit configured to specify position information indicating a position in the collection file corresponding to the extracted data; and

a registration unit configured to register a management record in a database, the management record including the attribute corresponding to the extracted data, the specified position information, and file identification information about the collection file associated with the extracted data.

A third example aspect of the present disclosure is a data management method performed by a computer. The data management method includes:

extracting a pair of an attribute and data based on a format corresponding to each collection file from a plurality of collection files collected from an information system and described in a plurality of respective types of the formats;

specifying position information indicating a position in the collection file corresponding to the extracted data; and

registering a management record in a database, the management record including the attribute corresponding to the extracted data, the specified position information, and file identification information about the collection file associated with the extracted data.

A fourth example aspect of the present disclosure is a data management program for causing a computer to execute:

a process of extracting a pair of an attribute and data based on a format corresponding to each collection file from a plurality of collection files collected from an information system and described in a plurality of respective types of the formats;

a process of specifying position information indicating a position in the collection file corresponding to the extracted data; and

a process of registering a management record in a database, the management record including the attribute corresponding to the extracted data, the specified position information, and file identification information about the collection file associated with the extracted data.

### Advantageous Effects of Invention

According to the present disclosure, it is possible to provide an information processing apparatus, a data management system, a data management method, and a data management program for uniformly managing data in files for a plurality of different purposes.

### BRIEF DESCRIPTION OF DRAWINGS

FIG. 1 is a block diagram showing a configuration of an information processing apparatus according to a first example embodiment;

FIG. 2 is a flowchart for explaining a flow of a data management method according to the first example embodiment;

FIG. 3 is a block diagram showing an entire configuration including a data management system according to a second example embodiment;

FIG. 4 is a diagram for explaining a concept of a collection file according to the second example embodiment;

FIG. 5 is a diagram for explaining an example of a configuration file according to the second example embodiment;

FIG. 6 is a diagram for explaining an example of a configuration file according to the second example embodiment;

FIG. 7 is a block diagram showing a configuration of a data management apparatus according to the second example embodiment;

FIG. 8 is a diagram for explaining an example of output definition information according to the second example embodiment;

FIG. 9 is a diagram for explaining an example of output definition information according to the second example embodiment;

FIG. 10 is a diagram for explaining an example of a management record according to the second example embodiment;

FIG. 11 is a diagram for explaining another example of the management record according to the second example embodiment;

FIG. 12 is a flowchart for explaining a flow of data registration processing according to the second example embodiment;

FIG. 13 is a diagram for explaining an example of a display screen and output information in a management terminal according to the second example embodiment;

FIG. 14 is a flowchart for explaining a flow of data output processing according to the second example embodiment;

FIG. 15 is a diagram for explaining an example of a display screen and output information in a management terminal according to a third example embodiment;

FIG. 16 is a diagram for explaining an example of a display screen and output information in a management terminal according to a fourth example embodiment; and

FIG. 17 is a diagram for explaining an example of a display screen and output information in a management terminal according to a fifth example embodiment.

### DESCRIPTION OF EMBODIMENTS

Hereinafter, example embodiments of the present disclosure will be described in detail with reference to the drawings. In each drawing, the same or corresponding elements are denoted by the same reference signs, and repeated description is omitted as necessary for clarification.

### First Example Embodiment

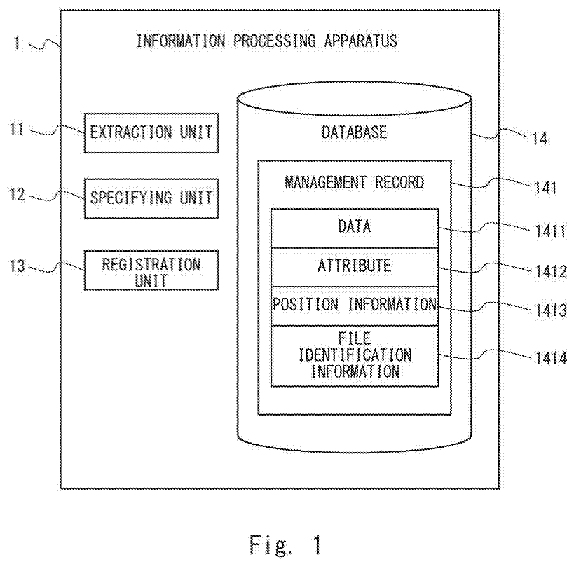

FIG. 1 is a block diagram showing a configuration of an information processing apparatus 1 according to a first example embodiment. The information processing apparatus 1 is a computer system for uniformly managing data in files for a plurality of different purposes. The information processing apparatus 1 may be implemented by a plurality of computers.

The information processing apparatus 1 inputs a plurality of collection files and processes them. The plurality of collection files are collected from an information system (not shown). Note that the information system is composed of a computer, a communication device, a storage apparatus, and so on. The information system is, for example, a service providing system for providing predetermined services via a network, a business system in an enterprise, or the like.

The plurality of collection files are electronic data described in a plurality of respective types of formats. In other words, each collection file is a file in which data is described in any of a plurality of formats. The number of types of format applied to each collection file is at least two. The collection file is, for example, a server configuration file, a log file, or an inventory file including an execution result of a predetermined command. Not only the formats of the plurality of collection files are different for a specific purpose, but also the plurality of collection files include files for different purposes. The format is at least information defining rules for describing data, such as delimiters between data. Further, the format may include a specification of a configuration such as the types of a plurality of attributes corresponding to each data, the order of the attributes, and the positional relation between the attributes. Therefore, it is assumed that the plurality of collection files include a plurality of data records including a set of data corresponding to each attribute based on a corresponding format.

The information processing apparatus 1 includes an extraction unit 11, a specifying unit 12, a registration unit 13, and a database 14. The extraction unit 11 extracts a pair of an attribute and data from each of the plurality of collection files based on the format corresponding to the corresponding collection file. Here, the attribute is information indicating the property or characteristic of the corresponding data, a type of a parameter, a character string of a parameter name, and the like. The attribute may further include elements, properties, etc., depending on the format.

The specifying unit 12 is an example of a first specifying unit, and specifies position information indicating a position in the collection file corresponding to the data extracted by the extraction unit 11. The position information here includes information for identifying a data record to which the extracted data belongs in the corresponding collection file and a positional relation in the data record in the corresponding attribute. Note that the position information may be an address value or the like in the collection file.

The registration unit 13 registers a management record 141 in the database 14. In the management record 141, a corresponding attribute 1412, identified position information 1413, and file identification information 1414 of the corresponding collection file are associated with the extracted data 1411.

Here, the extraction unit 11, the specifying unit 12, and the registration unit 13 are implemented by a control unit (not shown) in the information processing apparatus 1 reading and executing a data management program according to this example embodiment.

The database 14 is a set of data stored in a storage apparatus (not shown) inside the information processing apparatus 1. However, the storage apparatus may be an external apparatus connected to the information processing apparatus 1. The database 14 manages a plurality of the management records 141. The management record 141 is information in which the data 1411, the attribute 1412, the position information 1413, and the file identification information 1414 are associated with each other. The combination of the attribute 1412, the position information 1413, and the file identification information 1414 is a primary key for uniquely specifying the management record 141 or the data 1411. The database 14 is implemented, for example, by the above-described control unit reading and executing a predetermined database management program so as to manage the data in the above-described storage apparatus. The database 14 may be distributively managed.

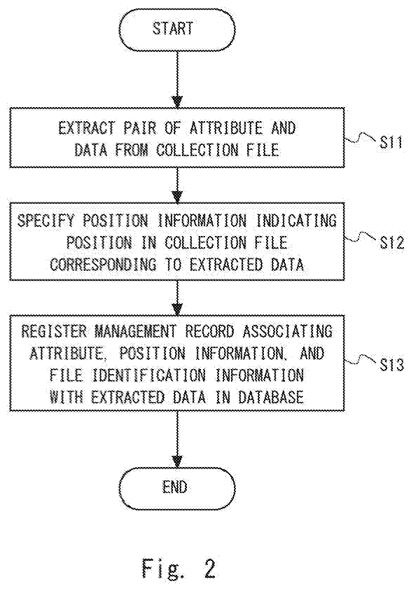

FIG. 2 is a flowchart for explaining a flow of a data management method according to the first example embodiment. First, the extraction unit 11 extracts a pair of an attribute and data from each of the plurality of collection files based on a format corresponding to the collection file (S11). The information related to the format may be stored in advance in the storage apparatus in the information processing apparatus 1. In this case, the extraction unit 11 may select the format in accordance with the collection file to be processed, read format information corresponding to the selected format from the storage apparatus, and extract a pair of an attribute and data using the format information. Alternatively, the extraction unit 11 may be implemented with an extraction logic corresponding to a plurality of types of formats in advance.

Next, the specifying unit 12 specifies the position information indicating a position in the collection file corresponding to the data extracted in Step S11 (S12). Then, the registration unit 13 registers a management record in the database 14 (S13). In the management record, the attribute corresponding to the extracted data, the identified position information, and the file identification information about the corresponding collection file are associated with the extracted data.

As described above, in this example embodiment, a data record is divided, not by the unit of data record and instead by the unit of data for each of a plurality of attributes in each data record, from the plurality of collection files described in the plurality of types of format. At this time, each data is associated with a corresponding attribute as a one-to-one pair of data and an attribute. However, a plurality of data pieces corresponding to the same attribute may be included in a data record. For this reason, the data included in the data record cannot be uniquely identified only by the attribute. Thus, the position information in the collection file is specified for each extracted data. Then, the attribute, the position information, and the file identification information are associated with each extracted data and registered in the database. By doing so, the collection file to which the data belongs can be specified, the position in the file can be specified, and the attribute indicating the characteristic of the data can also be specified. It is thus possible to appropriately select the data in the database in response to various requests and process the data. Therefore, according to this example embodiment, it is possible to uniformly manage the data in the files for a plurality of different purposes.

In Patent Literature 1 to 3, data is managed in units of records, and attributes in records are associated between different formats. In this way, the data can only be utilized within the scope of the unified format. For this reason, the data depends on the format of the unified format. On the other hand, in this example embodiment, the data is decomposed into units of values (data) and not into units of records. Further, not only an attribute but also a unique identifier within a file is added to each value, so that the data is stored as a combination of the identifier within the file and the value. Then, the divided data can be utilized from various points of view.

### Second Example Embodiment

A second example embodiment is an application example of the above-described first example embodiment. The registration unit according to the second example embodiment further associates an update date and time of the collection file with the management record and registers them in the database. By doing so, an update history of the same collection file can be managed.

In addition to the configuration of the information processing apparatus 1 according to the first example embodiment, the information processing apparatus according to the second example embodiment preferably includes a storage unit, a reception unit, a second specifying unit, an acquisition unit, a generation unit, and an output unit described below. The storage unit here stores an output definition including a plurality of the attributes to be output and the file identification information in association with each other. The reception unit receives an output condition including first file identification information corresponding to the collection file. The second specifying unit specifies a first output definition associated with the first file identification information from the storage unit. The acquisition unit acquires a plurality of first management records corresponding to a combination of any of the attributes included in the first output definition and the first file identification information from the database. The generation unit generates first output information by connecting data in the plurality of first management records based on each of the first output definition and the position information in the plurality of first management records. The output unit outputs the first output information. In this way, the collection file can be restored and output. Then, it becomes unnecessary to store the original collection file, and thus the storage cost can be reduced.

The registration unit preferably organizes the attribute extracted by the extraction unit by each collection file from which the attribute is extracted to generate the output definition, and registers the file identification information about the collection file from which the attributes are extracted and the generated output definition in the storage unit in association with each other. In this way, the output definition of a plurality of attributes used in the collection file can be automatically generated.

The generation unit classifies a plurality of records corresponding to the same attribute included in the first output definition among the plurality of first management records into a plurality of different groups based on the position information. Then, the generation unit preferably generates the output information for each record classified into each group. In this manner, the output information can be restored to correspond to the original data record.

Note that the plurality of collection files may include a configuration file corresponding to a first apparatus included in the information system, and the file identification information may include identification information about the first apparatus. By doing so, the collection file can be identified by a host and the like targeted by the configuration file even if the configuration file name is the same.

It is preferable that the plurality of collection files include command execution results for a second apparatus included in the information system. Thus, the execution result (inventory) by a diagnostic command for the information system can also be uniformly managed.

The plurality of collection files may include a plurality of data records including a set of data corresponding to each attribute based on the corresponding format. In this case, the first specifying unit may include, in the position information, information for identifying the data record to which the extracted data belongs in the corresponding collection file and the positional relation in the data record in the corresponding attribute in the corresponding collection file to specify the position information. Thus, the data record in the original file can be accurately restored by using the position information.

The data management system according to the second example embodiment is regarded that it includes a collection unit, an extraction unit, a first specifying unit, and a registration unit described below. The collection unit collects a plurality of collection files described in a plurality of respective types of formats from the information system and stores them in a storage apparatus. The extraction unit extracts a pair of an attribute and data from each of the plurality of collection files stored in the storage apparatus based on the format corresponding to each collection file. The first specifying unit specifies position information indicating a position in the collection file corresponding to the extracted data. The registration unit registers a management record in the database. In the management record, the attribute corresponding to the extracted data, the identified position information, and the file identification information about the collection file are associated with the extracted data.

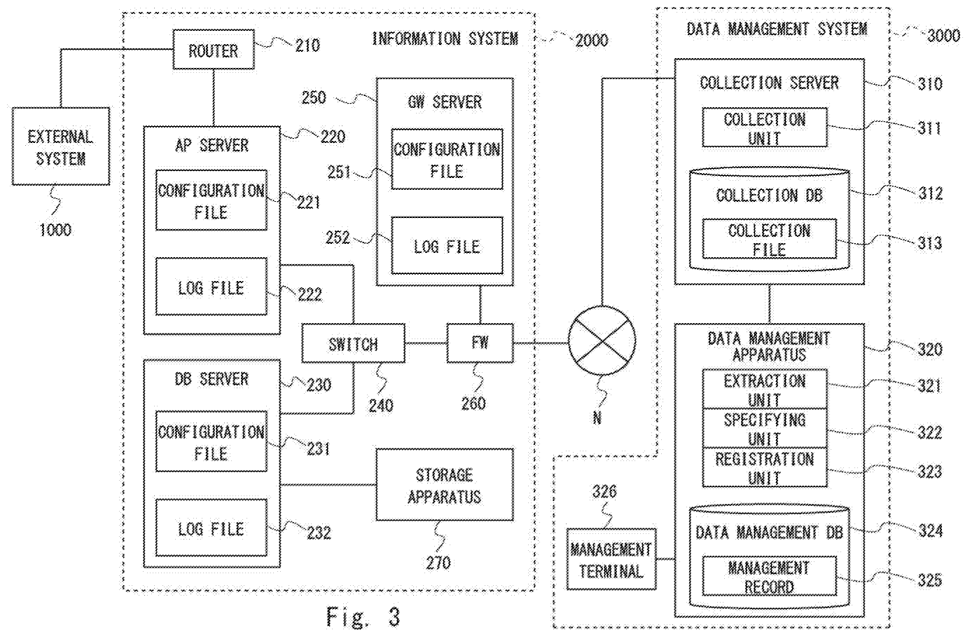

FIG. 3 is a block diagram showing an entire configuration including a data management system 3000 according to the second example embodiment. FIG. 3 shows an external system 1000, an information system 2000, and the data management system 3000. The information system 2000 is a system for providing data to be managed by the data management system 3000 according to this example embodiment in a plurality of collection files. The information system 2000 may be the above-described service providing system, an internal business system, or the like. Although the external system 1000 is connected to the information system 2000 via a network (not shown), the data of the external system 100 is not subject to be managed by the data management system 3000. The information system 2000 and the data management system 3000 are connected via a network N. The network N is a communication network such as the Internet or a leased line.

The information system 2000 includes a router 210, an AP (Application) server 220, a DB (DataBase) server 230, a switch 240, a GW (GateWay) server 250, an FW (FireWall) 260, and a storage apparatus 270. However, the configuration of the information system 2000 is not limited to this. The connection relation between the components of the information system 2000 is not also limited to this. The information system 2000 may include at least one or more of a computer server, a network device, a storage apparatus, and so on, and may provide files for a plurality of different purposes.

The router 210 is a network device connected to the external system 1000 and the AP server 220 that routes communication packets passing through the communication inside and outside the information system 2000.

The AP server 220 is a computer in which an AP server as middleware runs, and an application running on the AP server and providing predetermined services runs. The AP server 220 is connected to the router 210 and the switch 240. The AP server 220 stores a configuration file 221 and a log file 222 in an internal storage apparatus (not shown). Note that the number of each of the configuration file 221 and the log file 222 may be two or more. In the configuration file 221, setting values of an OS (Operating System), an AP server, an application or the like are defined for each attribute. In the log file 222, log messages of the OS, the AP server, the application or the like are recorded. The AP server 220 may be implemented by a plurality of computers.

The DB server 230 is a computer on which a DB server (DB management system) as middleware runs that manages data stored in the storage apparatus 270. The DB server 230 is connected to the switch 240 and the storage apparatus 270. The DB server 230 stores a configuration file 231 and a log file 232 in an internal storage apparatus (not shown). Note that the number of each of the configuration file 231 and the log file 232 may be two or more. In the configuration file 231, setting values of an OS, a DB server or the like are defined for each attribute. In the log file 232, log messages of the OS, the DB server or the like are recorded. The DB server 230 may be implemented by a plurality of computers.

The storage apparatus 270 is a storage apparatus connected to the DB server 230. The storage apparatus 270 stores a set of data managed by the DB server 230. The switch 240 is a network device connected to the AP server 220, the DB server 230, and the FW 260 that relays communication data passing through the AP server, the DB server, and the FW. The FW 260 is a network device connected to the switch 240, the GW server 250, and the network N, and relays and monitors communication between the inside of the information system 2000 and the network N.

The GW server 250 is a computer connected to the FW 260 that converts protocols between the information system 2000 and the network N. The GW server 250 stores a configuration file 251 and a log file 252 in an internal storage apparatus (not shown). Note that the number of each of the configuration file 251 and the log file 252 may be two or more. In the configuration file 251, setting values of an OS, a GW server or the like are defined for each attribute. In the log file 252, log messages of the OS, the GW server or the like are recorded. The GW server 250 may be implemented by a plurality of computers.

It is assumed that each of a plurality of setting contents is defined as a data record in the configuration files 221, 231, and 251, and one or more attributes (installation item) and one or more setting values are set in each data record. However, each of the configuration files 221 and the like may have a format different from each other. Each of the configuration files 221 and the like may be regarded as a configuration file corresponding to the first apparatus included in the information system 2000.

In addition, the log files 222, 232, and 252 are appropriately updated by addition. Each of the log files 222 and the like may have a format different from each other. Note that the router 210, the switch 240, the FW 260, and the storage apparatus 270 may store the configuration file or the log file in an internal storage apparatus (not shown), or may include them in the collection file.

The data management system 3000 includes a collection server 310, a data management apparatus 320, and a management terminal 326. The collection server 310 is an information processing apparatus that collects and stores a plurality of collection files from the information system 2000 via the network N. The collection server 310 is connected to the network N and the data management apparatus 320. The collection server 310 may be implemented by a plurality of computers. The collection server 310 includes a collection unit 311 and a collection DB 312.

The collection unit 311 collects a plurality of collection files from the information system 2000 via the network N periodically or in response to an instruction from the management terminal 326 issued by an administrator. For example, the collection unit 311 acquires the configuration file 221 and the log file 222 from the AP server 220 via the network N, and stores them in the collection DB 312. The collection unit 311 acquires the configuration file 231 and the log file 232 from the DB server 230 via the network N, and stores them in the collection DB 312. The collection unit 311 acquires the configuration file 251 and the log file 252 from the GW server 250 via the network N, and stores them in the collection DB 312. Note that the collection unit 311 may obtain a configuration file or a log file from the router 210, the switch 240, the FW 260, and the storage apparatus 270 via the network N, and store it in the collection DB 312. The collection unit 311 issues a predetermined diagnostic command for the second apparatus included in the information system 2000 via the network N periodically or in response to an instruction from the management terminal 326 issued by the administrator. Then, the collection unit 311 stores a command execution result, which is a response to the diagnostic command, in the collection DB 312 as an inventory file. For example, the collection unit 311 issues a predetermined diagnostic command for at least one of the router 210, the AP server 220, the DB server 230, the switch 240, the GW server 250, the FW 260, and the storage apparatus 270 via the network N. Note that the diagnostic command is, for example, a ping command, but is not limited to this. Note that the collection unit 311 is implemented by a control unit (not shown) in the collection server 310 reading and executing a predetermined collection program.

The collection DB 312 is a set of data stored in a storage apparatus (not shown) inside the collection server 310. The storage apparatus may be an external apparatus connected to the information processing apparatus 1. The collection DB 312 manages a plurality of collection files 313. The plurality of collection files 313 include the configuration files 221, 231, and 251, log files 222, 232, and 252, and at least two or more of the above-described inventory files. Thus, the plurality of collection files 313 are regarded that they include different types of configuration files, log files, and inventory files, are files for different purposes, and described in the plurality of respective types of formats.

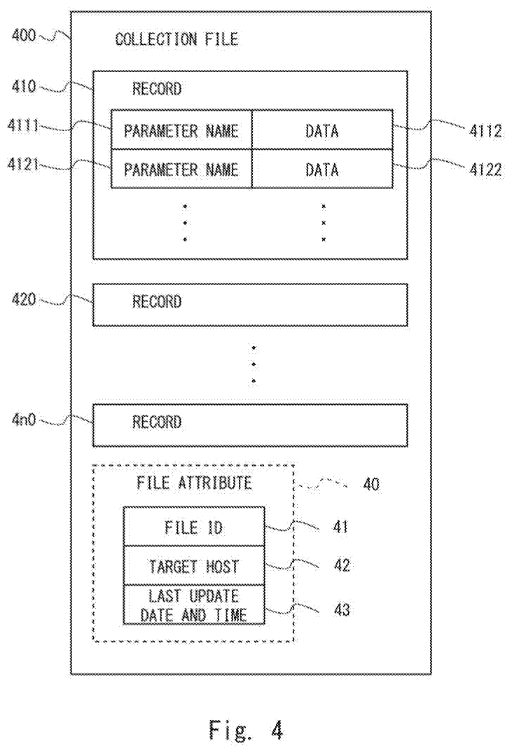

FIG. 4 is a diagram for explaining the concept of the collection file according to the second example embodiment. The collection file 400 is a generalization of the above-described collection file 313. A plurality of records 410, 420, . . . 4n0 (n is a natural number greater than or equal to 2) are described in the collection file 400. A record 410 includes a pair of parameter name 4111 and data 4112, a pair of parameter name 4121 and data 4122, and so forth. That is, the data 4112 is a setting value or the like corresponding to the parameter name 4111. Likewise, the data 4122 is a setting value or the like corresponding to the parameter name 4121. In the collection file 400, a file ID 41, a target host 42, and a last update date and time 43 are set as the file attribute 40. The file ID 41 is information such as a file name and a directory where the file is stored. The target host 42 is identification information about a device that provides the records 410 and the like described in the collection file 400, namely, a host ID. For example, when the collection file 400 is the configuration file 221, the target host 42 is a machine name, an IP (Internet Protocol) address, or the like of the AP server 220. When the collection file 400 is an inventory file, the target host 42 is a host in which the diagnostic command is executed. The file ID 41 and the target host 42 are examples of the file identification information about the collection file 400. However, the target host 42 is not an essential component. The last update date and time 43 is a time stamp indicating the date, time, minute, and second (or milliseconds) when the collection file 400 is last updated in the target host. Note that if the collection file 400 is an inventory file, the last update date and time 43 is the execution time of the diagnostic command or the time when the inventory file is stored in the collection server 310.

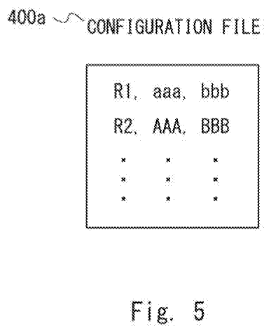

FIG. 5 is a diagram for explaining an example of a configuration file 400a according to the second example embodiment. The configuration file 400a is an example of the collection file 400, and is a CSV (Comma-Separated Values) format file in which each data record is separated by a newline character and a plurality of attribute values in the data record are separated by a comma. In this case, for example, a newline character and a comma character are defined as delimiters in the format information corresponding to the configuration file 400a. The format information may define attribute types and order such that a first attribute of each data record is a record ID, a second attribute thereof is a parameter 1, and a third attribute thereof is a parameter 2.

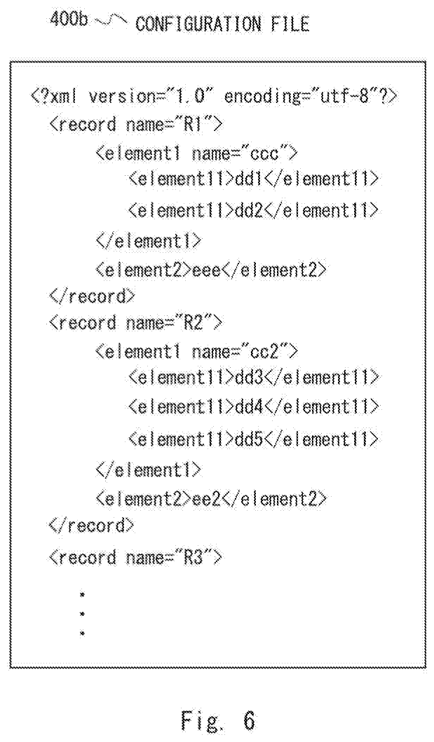

FIG. 6 is a diagram for explaining an example of a configuration file 400b according to the second example embodiment. The configuration file 400b is an example of the collection file 400, and indicates that it is an XML (eXtensible Markup Language) format file. In this case, the format information corresponding to the configuration file 400b defines, for example, that the configuration file 400b is an XML format. Further, the format information may define that the element of the data record is “record”, the child elements of the data record are “element1” and “element2”, and the child elements of “element1” are a plurality of “element11”.

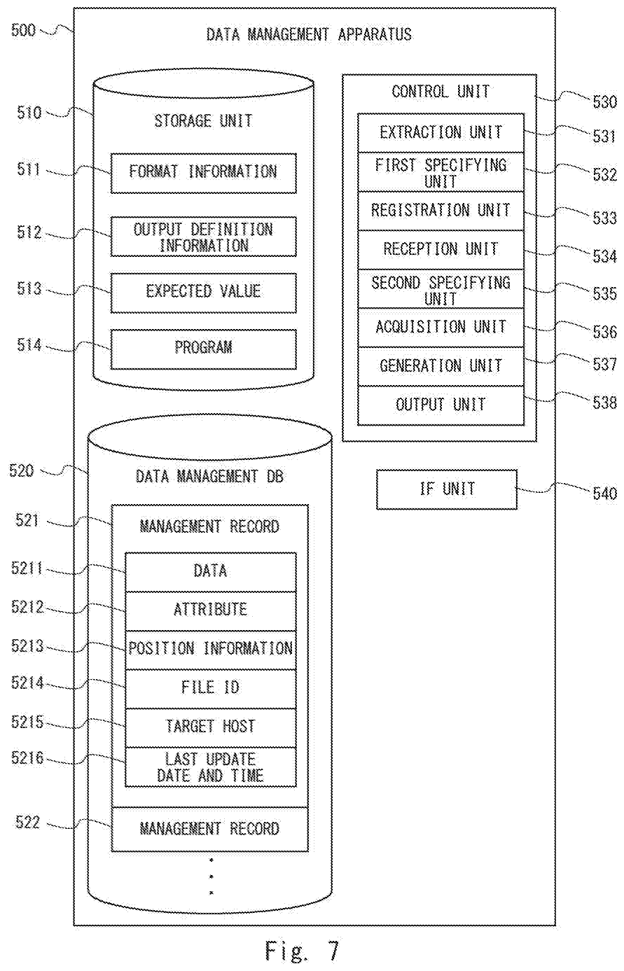

Referring back to FIG. 3, the description will be continued. The data management apparatus 320 is an example of the information processing apparatus 1 described above, and is a computer connected to the collection server 310 and the management terminal 326. The data management apparatus 320 reads a plurality of collection files 313 from the collection DB 312 and registers a plurality of management records 325 in the data management DB 324. Further, the data management apparatus 320 acquires some of the management records 325 based on a predetermined output condition from the data management DB 324 at a predetermined timing or in accordance with an instruction from the management terminal 326 issued by the administrator, and outputs the management records to the management terminal 326 or the like in a predetermined output format. The data management apparatus 320 may be implemented by a plurality of computers. The data management apparatus 320 includes at least an extraction unit 321, a specifying unit 322, a registration unit 323, and a data management DB 324. Note that a configuration of the data management apparatus 320 is a schematic configuration, and a detailed configuration will be described later with reference to FIG. 7.

The management terminal 326 is a terminal apparatus operated by an administrator of the data management system 3000, for example, a personal computer. The management terminal 326 is communicably connected to the data management apparatus 320 via a network or the like, and accesses the data management apparatus 320 to input information or the like in response to an operation of the administrator. Note that the management terminal 326 may be connected to the collection server 310.

FIG. 7 is a block diagram showing a configuration of the data management apparatus 500 according to the second example embodiment. The data management apparatus 500 corresponds to the data management apparatus 320 of FIG. 3. The data management apparatus 500 includes a storage unit 510, a data management DB 520, a control unit 530, and an IF unit 540. Note that the data management DB 520 may be implemented on an external storage apparatus connected to the data management apparatus 500.

The storage unit 510 is a storage apparatus such as a hard disk or a flash memory. The storage unit 510 stores format information 511, output definition information 512, an expected value 513, and a program 514. As described above, the format information 511 is information defining the format of the configuration file 221, the log file 222, or the inventory file. The format information 511 is information indicating, for example, CSV, XML, JSON (JavaScript (registered trademark) Object Notation), and other formats.

The output definition information 512 is information that associates an output definition including a plurality of attributes to be output with file identification information about a collection file. The output definition information 512 is, for example, a display format for reproducing and displaying the format of the collection file, or a file format for extracting some of the attribute values used in the collection file and outputting them for performing statistical processing or the like. Alternatively, the output definition information 512 may be configuration information defining the data structure of the collection file.

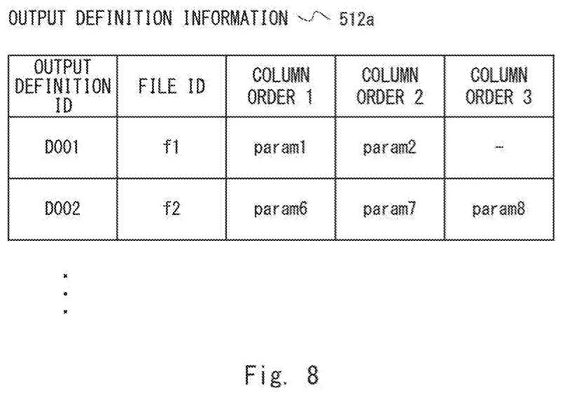

FIG. 8 is a diagram for explaining an example of output definition information 512a according to the second example embodiment. The output definition information 512a defines an output format or the like when the collection file is in the CSV format. For example, the output definition information 512a is a table including an output definition ID, a file ID, and column orders 1 to 3 as attributes. A character string indicating an attribute name (parameter name) is set in the column order 1 to 3. The column orders 1 to 3 indicate the order of attributes. The column order may be 2 or greater.

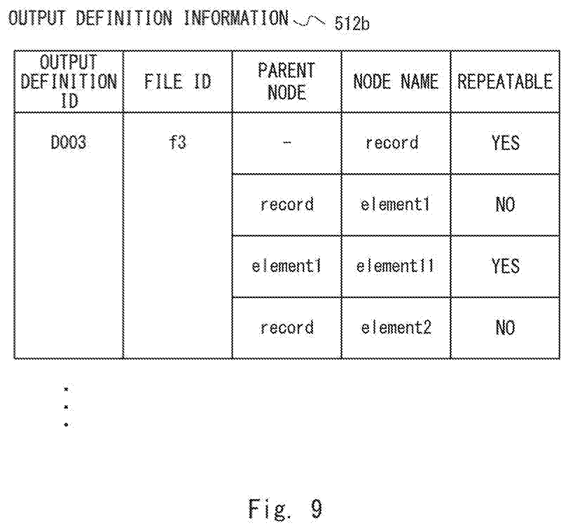

FIG. 9 is a diagram for explaining an example of output definition information 512b according to the second example embodiment. The output definition information 512b is information defining an output format or the like when the collection file is in the XML format. For example, the output definition information 512b is a table including an output definition ID, a file ID, a parent node, a node name, and “repeatable” (Yes/No) as attributes. The node name is a character string indicating the element to which the collection file belongs, the attribute, and the name of parameter for each output definition ID and file ID. The parent node indicates the parent node of the node name. That is, the parent node indicates the link destination of the child node. The “repeatable” is flag information indicating whether or not to allow the node to be repeatedly set. The output definition information 512b is not limited to this.

Referring back to FIG. 7, the description will be continued. The expected value 513 is a value to be compared with data corresponding to a predetermined attribute in a predetermined collection file. The program 514 is an example of the data management program, and is a computer program in which the data management processing according to this example embodiment is implemented. Note that the format information 511, the output definition information 512, and the expected value 513 may be information input from the management terminal 326.

The data management DB 520 corresponds to the data management DB 324 shown in FIG. 3 and is an example of the database 14 shown in FIG. 1. The data management DB 520 is, for example, KVS (Key-Value Store). The data management DB 520 may be distributively managed in a plurality of storage apparatuses. However, the data management DB 520 may be implemented by a relational database or other database system.

The data management DB 520 manages management records 521 and 522, and so forth. The management record 521 is information in which data 5211, an attribute 5212, position information 5213, a file ID 5214, a target host 5215, and a last update date and time 5216 are associated with each other. Note that the management record 522 has a similar configuration. When the data management DB 520 is KVS, for example, a set of the attribute 5212, the position information 5213, the file ID 5214, the target host 5215, and the last update date and time 5216 is KEY, and the data 5211 is VALUE. However, KEY may be at least a set of the position information 5213, the file ID 5214, and the last update date and time 5216. The target host 5215 may be used instead of the file ID 5214.

The data 5211 is an example of the data 1411 described above, and is information corresponding to the data 4112 or the like in FIG. 4. The attribute 5212 is an example of the attribute 1412 described above, and is information corresponding to the parameter name 4111 or the like in FIG. 4. The position information 5213 is an example of the position information 1413 described above. That is, the position information 5213 includes information for identifying the data record to which the extracted data belongs in the corresponding collection file, and positional relation in the data record in the corresponding attribute. The information for identifying the data record is, for example, a record ID. The positional relation in the data record is, for example, the column sequence number in FIG. 8, the hierarchical structure of the node in FIG. 9, the hierarchical number, the connection relationship of the nodes, and the like. The file ID 5214 and the target host 5215 are examples of the above-described file identification information 1414, and are information corresponding to the file ID 41 and the target host 42 in FIG. 4. The last update date and time 5216 is information corresponding to the last update date and time 43 in FIG. 4.

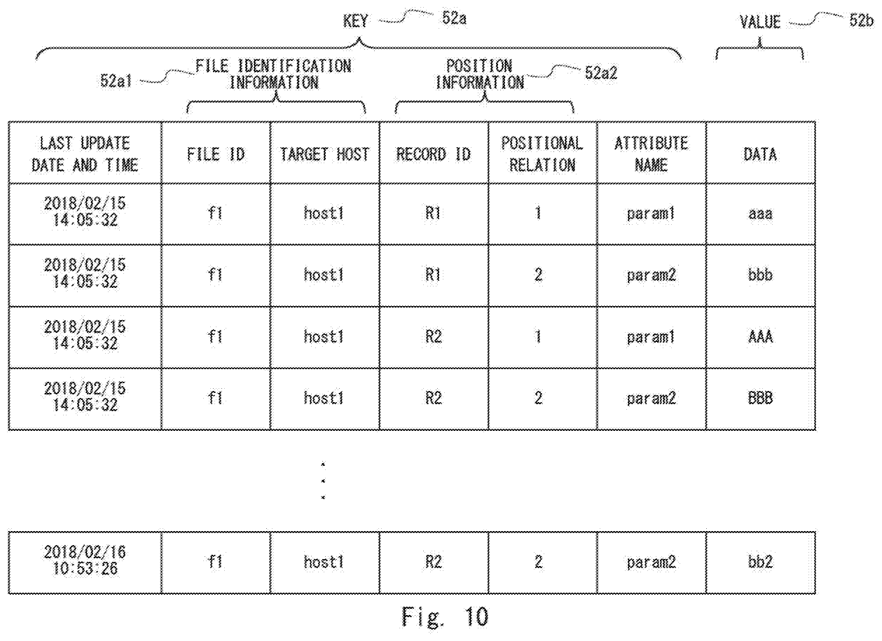

FIG. 10 is a diagram for explaining an example of the management record according to the second example embodiment. Here, an example of the management code corresponding to the configuration file 400a of FIG. 5 is shown. Here, the KEY 52a of the management record is a set of the last update date and time, the file ID, the target host, the record ID, the positional relation, and the attribute name. The file ID and the target host may be referred to as file identification information 52a1, and the record ID and the positional relation may be referred to as position information 52a2. A VALUE 52b of the management record is data.

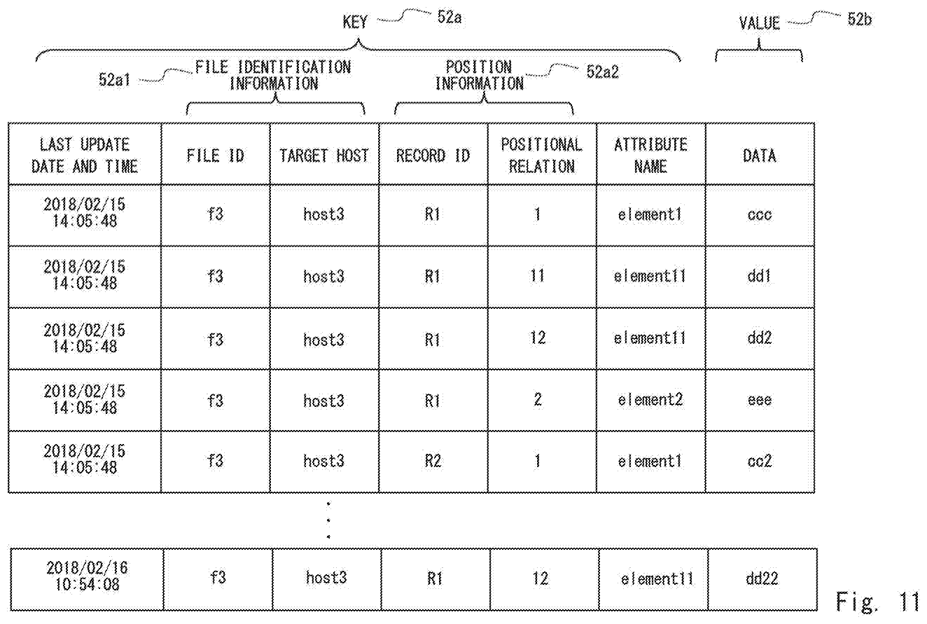

FIG. 11 is a diagram for explaining another example of the management record according to the second example embodiment. Here, an example of the management code corresponding to the configuration file 400b in FIG. 6 is shown. The positional relation is information indicating the hierarchical structure of the elements, but is not limited to this.

Referring back to FIG. 7, the description will be continued. The control unit 530 includes a processor such as a CPU and a memory, and controls each component of the data management apparatus 500. The processor of the control unit 530 reads the program 514 from the storage unit 510 into a memory and executes the program 514. In this manner, the control unit 530 implements the functions of an extraction unit 531, a first specifying unit 532, a registration unit 533, a reception unit 534, a second specifying unit 535, an acquisition unit 536, a generation unit 537, and an output unit 538.

The extraction unit 531 is an example of the extraction unit 11 in FIG. 1 and corresponds to the extraction unit 321 in FIG. 3. The extraction unit 531 extracts a pair of an attribute 5212 and data 5211 from each of the plurality of collection files 313 in the collection DB 312 based on the format information 511 corresponding to each collection file.

The first specifying unit 532 is an example of the specifying unit 12 in FIG. 1 and corresponds to the specifying unit 322 in FIG. 3. The first specifying unit 532 specifies the position information 5213 indicating a position in the collection file corresponding to the data extracted by the extraction unit 531. In particular, the first specifying unit 532 includes, in the position information 5213, information for identifying a data record to which the data extracted by the extraction unit 531 belongs in the corresponding collection file and the positional relation in the data record in the corresponding attribute in the corresponding collection file to specify the position information 5213.

The registration unit 533 is an example of the registration unit 13 shown in FIG. 1 and corresponds to the registration unit 323 shown in FIG. 3. The registration unit 533 generates the management record 521 in which the corresponding attribute 5212, the specified position information 5213, the file ID 5214 of the collection file, and the target host 5215 are associated with the extracted data 5211. The registration unit 533 further associates the last update date and time 5216 of the collection file with the management record 521 and registers them in the data management DB 520. The registration unit 533 also organizes the attribute extracted by the extraction unit 531 by each collection file from which the attribute is extracted to generate the output definition. Then, the registration unit 533 registers the file identification information about the collection file from which the attribute is extracted and the generated output definition in the storage unit 510 in association with each other as the output definition information 512.

The reception unit 534 receives an output condition including the first file identification information corresponding to the collection file. For example, the reception unit 534 receives the output condition input by the administrator using the management terminal 326. The second specifying unit 535 specifies the first output definition (output definition information 512) associated with the first file identification information from the storage unit 510. The acquisition unit 536 acquires a plurality of first management records corresponding to a combination of any of attributes included in the first output definition and the first file identification information from the data management DB 520. The generation unit 537 connects data in the plurality of first management records based on each of the first output definition and the position information 5213 in the plurality of first management records to generate the first output information. In particular, the generation unit 537 classifies a plurality of records corresponding to the same attribute included in the first output definition among the plurality of first management records into a plurality of different groups based on the position information, and generates output information for each record classified into each group. The output unit 538 outputs the first output information. For example, the output unit 538 transmits the first output information to the management terminal 326 for display. Alternatively, the output unit 538 outputs the first output information in an external storage apparatus or the like to be stored.

The IF unit 540 is an interface for communicating with the outside of the data management apparatus 500. For example, the IF unit 540 receives a request from the management terminal 326 and outputs the request to the control unit 530. Further, the IF unit 540 receives an instruction from the control unit 530 and outputs it to the management terminal 326. The IF unit 540 transmits a read request for reading the collection file 313 to the collection DB 312 in response to an instruction from the control unit 530, and outputs the received collection file 313 as a response to the control unit 530.

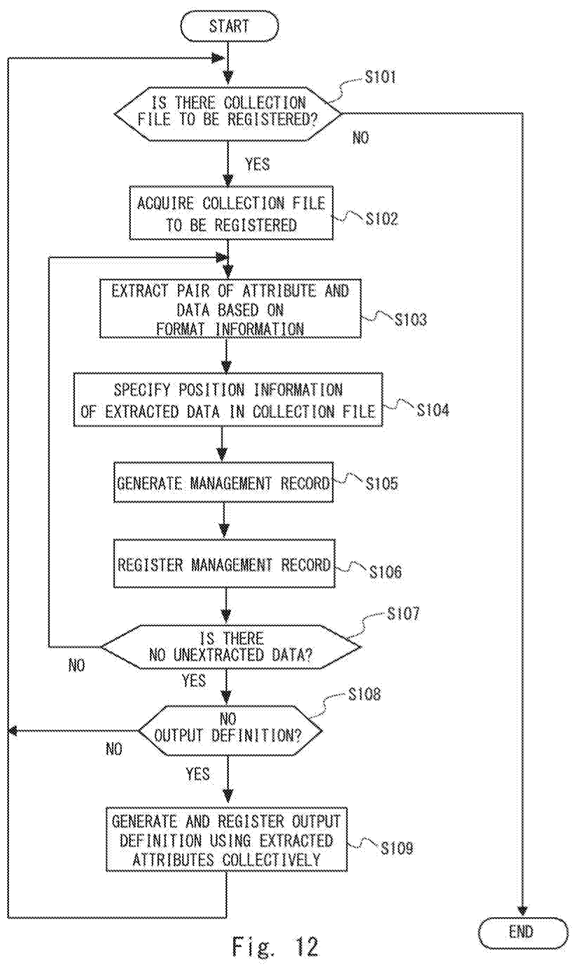

FIG. 12 is a flowchart for explaining a flow of the data registration processing according to the second example embodiment. First, the data management apparatus 500 starts data registration processing at a predetermined timing or in accordance with an instruction from the management terminal 326 issued by the administrator. Then, the extraction unit 531 refers to the collection DB 312 and determines whether there is a collection file 313 to be registered (S101). For example, when a flag indicating whether the data registration processing has been completed is managed for each collection file 313 in the collection DB 312, the extraction unit 531 makes a determination by the flag.

If the extraction unit 531 determines in Step S101 that there is a collection file 313 to be registered, it acquires the unregistered collection file 313 from the collection DB 312 as a file to be registered (S102). Then, the extraction unit 531 reads the corresponding format information 511 from the storage unit 510 according to the type of the acquired collection file 313. The extraction unit 531 extracts a pair of an attribute and data based on the read format information 511 (S103). Specifically, the extraction unit 531 first extracts one data record from the collection file 313 based on delimiter information about the data record defined in the format information 511. The extraction unit 531 divides the extracted data record into a plurality of data pieces based on the delimiter information about the attribute defined in the format information 511. The extraction unit 531 extracts a pair of each divided data and the attribute of the corresponding position based on the order and the positional relation of the attribute defined in the format information 511.

For example, if the acquired collection file is the configuration file 400a in FIG. 5, the extraction unit 531 extracts one line of data (“R1, aaa, bbb”) from the configuration file 400a as a data record. Next, the extraction unit 531 divides the extracted data record by a comma character into a plurality of data. Then, the extraction unit 531 extracts the first divided data (“R1”) as a pair of “R1” and the record ID, the second data (“aaa”) as a pair of “aaa” and param1, and the third data (“bbb”) as a pair of “bbb” and param2.

For example, if the acquired collection file is the configuration file 400b in FIG. 6, the extraction unit 531 extracts the data surrounded by the “record” tag from the configuration file 400b as one data record, and extracts a pair of the data “R1” and the record ID. The extraction unit 531 divides the extracted data record into data surrounded by the “element1” tag and the “element2” tag. The extraction unit 531 extracts a pair of data “ccc” and “element1” from the data surrounded by the divided “element1” tags. The extraction unit 531 divides the data surrounded by the divided “element1” tag into data surrounded by the “element11” tag. The extraction unit 531 extracts a pair of data “dd1” and “element11” from the data surrounded by the “element11” tag. Likewise, the extraction unit 531 extracts a pair of data “dd2” and “element11” and a pair of data “eee” and “element2”.

Furthermore, in Step S102, the first specifying unit 532 specifies the position information about each extracted data in the collection file (S104). For example, when the extraction unit 531 extracts a pair of data and an attribute from the collection file, the first specifying unit 532 holds the record ID in a memory or the like, and specifies the position information 52a2 as shown in FIGS. 10 and 11, for example, by counting the positional relation.

The registration unit 533 generates a management record for each pair of the extracted data and attribute (S105). For example, the registration unit 533 associates the pair of data and attribute extracted in Step S103 with the position information specified in Step S104 to form a management record. Then, the registration unit 533 associates the file ID 41, the target host 42, and the last update date and time 43 in the collection file 313 acquired in Step S102 with the management record.

After that, the registration unit 533 registers the generated management record in the data management DB 520 (S 106). For example, when the management records are processed in units of data records in Steps S103 to S105 as described above, the registration unit 533 generates management records corresponding to the number of data in the data records and registers the respective management records in the data management DB 520. Then, the control unit 530 determines whether there is unextracted data in the acquired collection file 313 (S107). For example, when the management records are processed in units of data records, the control unit 530 determines whether there is an unextracted data record.

If it is determined in Step S107 that there is unextracted data or a data record, Steps S103 to S107 are repeated. If it is determined in Step S107 that there is no unextracted data or data record, the control unit 530 determines whether the output definition information 512 corresponding to the acquired collection file 313 is present in the storage unit 510 (S108). If it is determined that there is no corresponding output definition information 512, the registration unit 533 generates a new output definition using the attributes extracted in Step S103 collectively. Then, the registration unit 533 registers the generated output definition and the file identification information about the collection file 313 acquired in Step S102 in the storage unit 510 in association with each other as the output definition information 512 (S109).

After Step S109 or when it is determined in Step S108 that there is the corresponding output definition information 512, the process returns to Step S101. If it is determined in Step S101 that there is the collection file 313 to be registered, Steps S102 to S109 are repeated. On the other hand, when it is determined in Step S101 that there is no collection file 313 to be registered, the data registration processing is ended.

Here, it is assumed that the data management apparatus 500 has, for example, a function of a WEB application. In this case, the data management apparatus 500 generates an input screen of the output condition and transmits the input screen to the management terminal 326. The management terminal 326 displays the received input screen on a display apparatus (not shown).

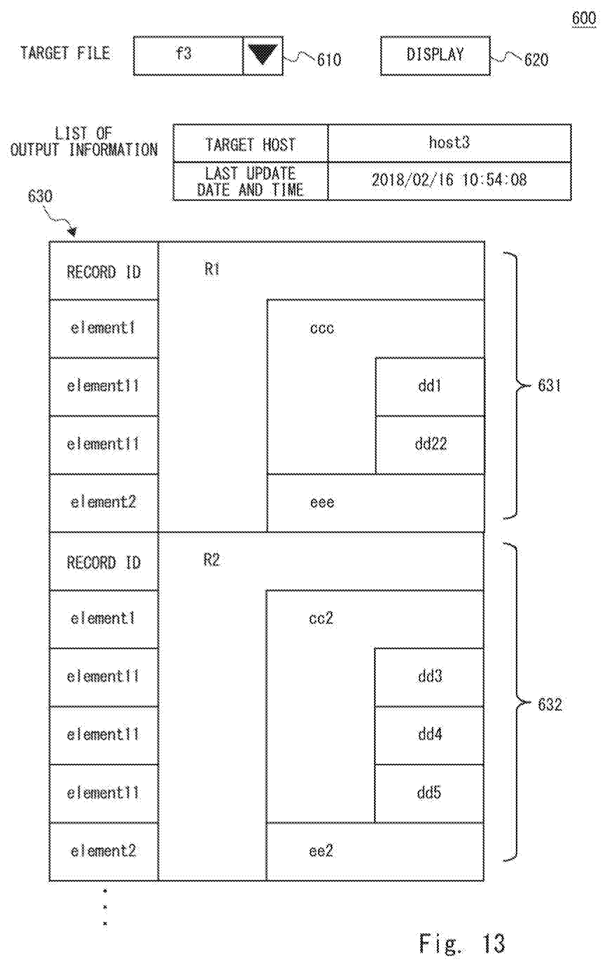

FIG. 13 is a diagram for explaining an example of a display screen 600 and output information 630 in the management terminal 326 according to the second example embodiment. It is assumed that the output information 630 is not displayed on the display screen 600 at this time. The display screen 600 includes a target file designation field 610 and a display button 620. The target file designation field 610 is a field for receiving a designation of the file identification information to be output by pull-down. The display button 620 is a button for transmitting the output condition including the file identification information designated in the target file designation field 610 to the data management apparatus 500 in response to the press of the button.

Here, the management terminal 326 receives an operation of inputting or selecting the output condition from the administrator using an input apparatus (not shown). For example, the management terminal 326 receives a designation operation of the target file from the administrator in the target file designation field 610. The designating operation is, for example, an operation of pulling-down. The management terminal 326 receives the operation of pressing the display button 620 from the administrator. In response to this, the management terminal 326 transmits the output condition including first file identification information (f3) indicated by the target file designated in the target file designation field 610 to the data management apparatus 500.

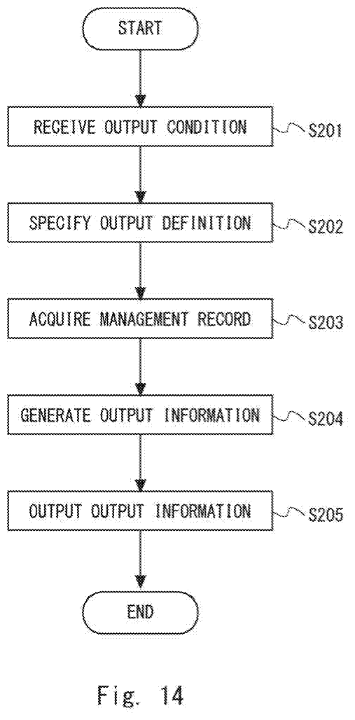

FIG. 14 is a flowchart for explaining a flow of data output processing according to the second example embodiment. The reception unit 534 receives the output condition including the first file identification information from the management terminal 326 (S201). Next, the second specifying unit 535 specifies the output definition information 512 associated with the received first file identification information from the storage unit 510 (S202). For example, the second specifying unit 535 specifies the output definition information 512b associated with a file ID “f3”. Then, the acquisition unit 536 acquires a plurality of first management records corresponding to a combination of any of the attributes included in the specified output definition information 512 and the first file identification information from the data management DB 520 (S203). For example, the acquisition unit 536 acquires the latest management record from among the management records shown in FIG. 11 as the plurality of first management records.

The generation unit 537 connects the data (VALUE 52b) in the plurality of first management records based on each of the output definition information 512b and the position information 52a2 in the first management records to generate the first output information (S204). In particular, the generation unit 537 classifies a plurality of records corresponding to the same attribute (e.g., “element1”) included in the output definition information 512b into a plurality of different groups (e.g., “R1” and “R2”) based on the position information 52a2 (a pair of record ID and positional relation). The, the generation unit 537 generates the output information for each record classified into each group.

The output unit 538 outputs, i.e., transmits the output information generated in Step S204 to the management terminal 326 (S205). After that, the management terminal 326 displays the received output information on the display apparatus. For example, as shown in the display screen 600 of FIG. 14, the output information 630 is displayed. The output information 630 indicates that two records of record data 631 and 632 are displayed. That is, in the record data 631, all pairs of attributes and data included in a record R1 are collected, and in the record data 632, all pairs of attributes and data included in the record R2 are collected. The display format is not limited to this. When the administrator designates another target file on the display screen 600, the data included in the target file can be read and displayed based on the output definition corresponding to the designated target file.

As described above, in this example embodiment, data for a plurality of different purposes and various formats can be uniformly managed, and collection data can be easily utilized. For example, the collection file can be applied to any of a configuration file, a log file, and an inventory. As described above, the contents of the collection file can be reproduced and displayed on the display screen 600. It is thus not necessary to store the original collection file, thereby reducing the storage cost and effectively using the storage area.

### Third Example Embodiment

A third example embodiment is an improved example of the second example embodiment. Here, problems from other points of view in Patent Literature 1 to 3 will be described. In Patent Literature 1 to 3, although log files of various formats can be unified into a common format, there is a problem that the application mode of collection data is limited, because each data in the unified format depends on the common format. For example, in Patent Literature 1 to 3, it is not possible to compare specific attribute values in the same kind of collection files in time series. That is, in Patent Literature 1, since the results of the statistical processing are stored in a specific display format, the application mode is limited. Further, in Patent Literature 2, log messages of a plurality of formats are converted into a common specific format and stored, and thus the application mode of the log messages depends on the specific format and is limited. Further, in Patent Literature 3, log messages of a plurality of formats are converted into a common specific format and stored in one log file for monitoring. For this reason, each data in the monitoring log file depends on a specific format, and the application mode of the data is limited.

In the third example embodiment, the following configuration is included. More specifically, the output condition further includes two or more pieces of time information to be compared. The acquisition unit acquires a plurality of second management records corresponding to any of the attributes included in the first output definition and any of the two or more pieces of time information included in the output condition from the database. The generation unit generates second output information so as to compare data associated with each of the two or more pieces of time information among the data in the plurality of second management records. The output unit outputs the second output information. Thus, the update history of the data of the specific attribute in the specific file can be compared. It is therefore possible to relieve the limitation of the application mode and increase the degree of freedom to achieve diversification. To diversify the application mode, for example, in addition to restoring the original collection file format, it is possible to extract and narrow down data from a specific point of view and compare specific attribute values in the same type of collection files in time series. The configuration of the data management apparatus according to the third example embodiment is the same as that of the second example embodiment except for the above. Thus, the configuration of the third example embodiment same as that of the second example embodiment are not shown and described in detail.

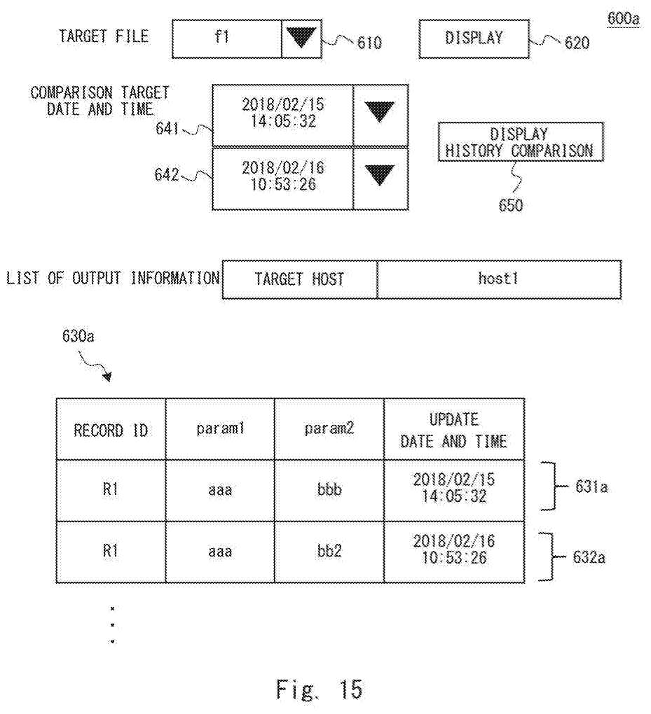

FIG. 15 is a diagram for explaining an example of a display screen 600a and output information 630a in the management terminal 326 according to the third example embodiment. First, as in the second example embodiment, it is assumed that the output information 630a is not initially displayed on the display screen 600a. The display screen 600a includes, in addition to the display screen 600, comparison target date and time designation fields 641 and 642 and a display history comparison button 650. The comparison target date and time designation fields 641 and 642 receive the designation of the comparison target dates and times by pull-down. In this case, although there are two comparison target date and time designation fields, the number of comparison target date and time designation fields may be three or more. The display history comparison button 650 is a button for transmitting an output condition including the file identification information designated in the target file designation field 610 and two dates and times designated in the comparison target date and time designation fields 641 and 642 to the data management apparatus 500 in response to the press of the button.

Here, for example, the management terminal 326 receives the designation of the date and time of the comparison target from the administrator in each of the comparison target date and time designation fields 641 and 642. The management terminal 326 receives the operation of pressing the display history comparison button 650 by the administrator. In response to this, the management terminal 326 transmits an output condition including the file identification information (f1) designated in the target file designation field 610 and two dates and times designated in the comparison target date and time designation fields 641 and 642 to the data management apparatus 500.

The reception unit 534 receives the output condition including the first file identification information and the two pieces of time information from the management terminal 326 (S201). The second specifying unit 535 specifies the output definition information 512 in the same manner as described above (S202). Then, the acquisition unit 536 acquires a plurality of second management records corresponding to any of the attributes included in the output definition information 512 and any of the two pieces of time information included in the output condition from the data management DB 520 (S203). For example, the acquisition unit 536 acquires a management record corresponding to each of the two latest update dates and times shown in FIG. 10 as the second management record.

Then, the generation unit 537 generates the second output information so as to compare the data associated with each of the two pieces of time information among the data in the plurality of second management records (S204). The output unit 538 outputs, i.e., transmits, the second output information (S205). After that, the management terminal 326 displays the received second output information on the display apparatus. For example, as shown in the display screen 600a of FIG. 15, the output information 630a is displayed. The output information 630a indicates that record data 631a and 632a having different update dates and times are displayed in such a way that they can be compared with each other for the same record ID “R1”.

As described above, according to this example embodiment, the update histories of the same file can be compared.

### Fourth Example Embodiment

A fourth example embodiment is an improved example of the second or third example embodiment. The output condition according to the fourth example embodiment further includes an expected value of data in the first attribute. The acquisition unit acquires a third management record corresponding to the first attribute from the database. The generation unit generates third output information so as to compare the data in the third management record with the expected value. The output unit outputs the third output information. Thus, the expected value can be compared with the actual setting value. Thus, the application mode can be further diversified. The configuration of the data management apparatus according to the fourth example embodiment is the same as that of the second or third example embodiment except for the above. Thus, the configuration of the fourth example embodiment same as that of the second and third example embodiments are not shown and described in detail.

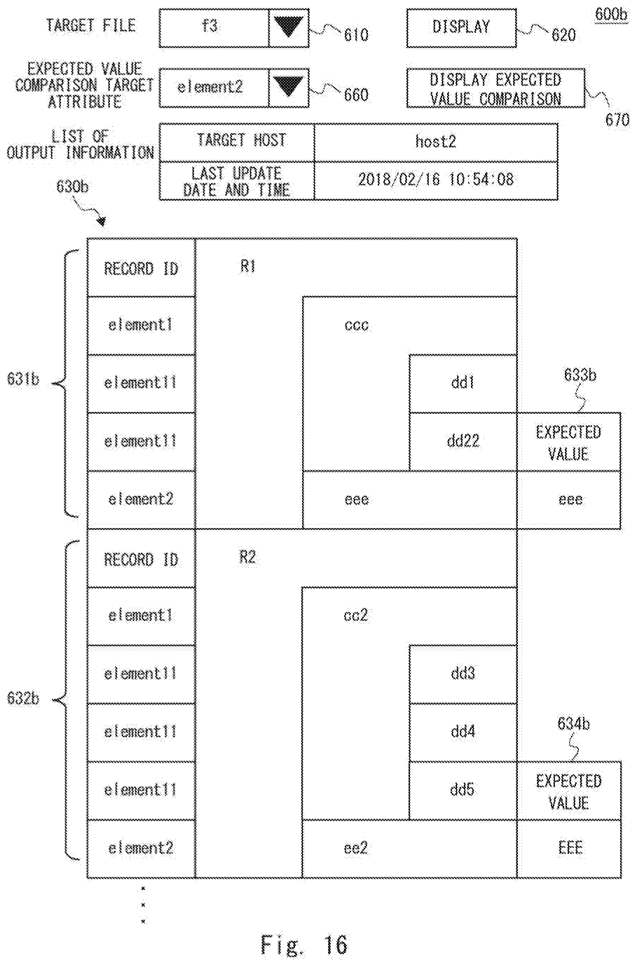

FIG. 16 is a diagram for explaining an example of a display screen 600b and output information 630b in the management terminal 326 according to the fourth example embodiment. First, as in the second example embodiment, it is assumed that the output information 630b is not initially displayed on the display screen 600b. The display screen 600b includes, in addition to the display screen 600, a comparison target attribute designation field 660 and a display expected value comparison button 670. Note that the display screen 600b may be an improved display screen 600a. The comparison target attribute designation field 660 is a field for receiving a designation of a target attribute to be compared with an expected value by pull-down. Although there is only one comparison target attribute designation field in this example, there may be two or more the comparison target attribute designation fields. In addition to the comparison target attribute designation field 660, a field for receiving an input of an expected value in the attribute may be included. The display expected value comparison button 670 is a button for transmitting the output condition including the file identification information designated in the target file designation field 610 and the attribute designated in the comparison target attribute designation field 660 to the data management apparatus 500 in response to the press of the button.

Here, for example, the management terminal 326 receives, from the administrator, a designation of an attribute to be compared with an expected value in the comparison target attribute designation field 660. Then, the management terminal 326 receives the operation of pressing the display expected value comparison button 670 from the administrator. In response to this, the management terminal 326 transmits the output condition including the file identification information (f3) designated in the target file designation field 610 and the attribute (element2) designated in the comparison target attribute designation field 660 to the data management apparatus 500. Note that if an input of the expected value is received, the management terminal 326 further transmits the input expected value.

The reception unit 534 receives the output condition including first file identification information and first attribute from the management terminal 326 (S201). Here, it is assumed that the reception unit 534 specifies the expected value 513 corresponding to the first attribute (element2) included in the output condition. Therefore, it can be said that the reception unit 534 receives the first file identification information, the first attribute to be compared, and the designation of the expected value as the output condition in Step S201. The second specifying unit 535 specifies the output definition information 512 in the same manner as described above (S202).

Then, the acquisition unit 536 acquires the third management record corresponding to the first attribute (element2) from the data management DB 520 (S203). The generation unit 537 generates the third output information so as to compare the data in the third management record with the expected value 513 (S204). The output unit 538 outputs, i.e., transmits, the third output information (S205).

After that, the management terminal 326 displays the received third output information on the display apparatus. For example, as shown in the display screen 600b of FIG. 16, the output information 630b is displayed. The output information 630b includes the record data 631b and 632b. The record data 631b is a record corresponding to a record ID “R1” in the file ID “f3”, and a record data 632b is a record corresponding to a record ID “R2” in the file ID “f3”. The record data 631b indicates that the actual setting value “eee” of the “element2” designated as the attribute to be compared is compared with the expected value 633b “eee”. Further, the record data 632b indicates that the actual setting value “ee2” of the “element2” designated as the attribute to be compared is displayed in such a way that it is compared with the expected value 634b “EEE”.

As described above, according to this example embodiment, it is possible to compare the expected value and the actual setting value, thereby further diversifying the application mode.

### Fifth Example Embodiment

A fifth example embodiment is an improved example of the second, third, or fourth example embodiment. The output condition according to the fifth example embodiment further includes second file identification information about a file having a common format with the collection file related to the first file identification information. The second specifying unit further specifies the second output definition associated with the second file identification information from the storage unit. The acquisition unit further acquires a plurality of fourth management records corresponding to a combination of any of the attributes included in the second output definition and the second file identification information from the database. The generation unit connects the data in the plurality of fourth management records based on each of the second output definition and the position information in the plurality of fourth management records to generate fourth output information. The output unit outputs the fourth output information so as to be compared with the first output information. Thus, a plurality of pieces of host information can be selected and compared in the units of the host. Therefore, it is possible to make a comparison across the files with respect to the attributes of the same quality, thereby further diversifying the application modes. The configuration of the data management apparatus according to the fifth example embodiment is the same as that of the second, third, or fourth example embodiment except for the above. Thus, the configuration of the fifth example embodiment same as that of the second, third, and fourth example embodiments are not shown and described in detail.

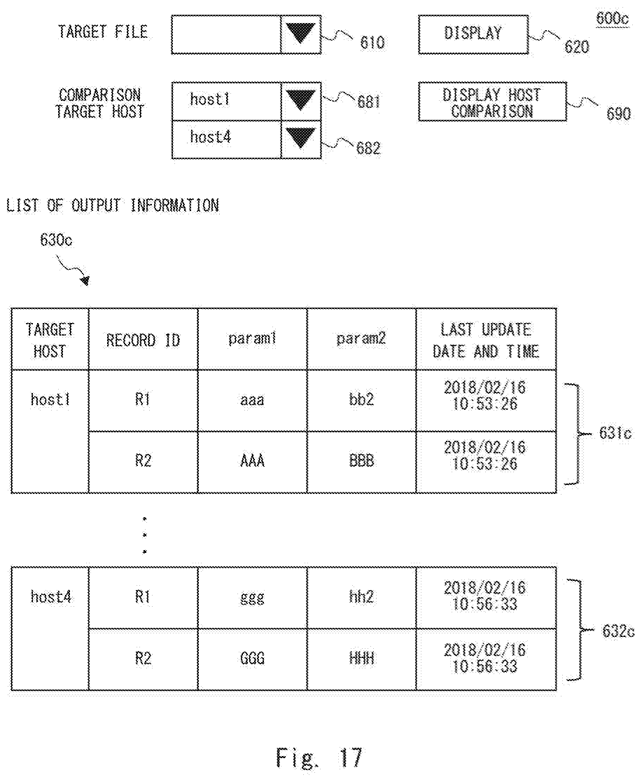

FIG. 17 is a diagram for explaining an example of the display screen 600c and output information 326 in the management terminal 630c according to the fifth example embodiment. First, as in the second example embodiment, it is assumed that the output information 600c is not initially displayed on the display screen 630c. The display screen 600c includes comparison target host designation fields 681 and 682 and a display host comparison button 690 in addition to the display screen 600. The display screen 600c may be an improved display screen 600a or 600b. The comparison target host designation fields 681 and 682 receive the designation of the comparison target host by pull-down. In this case, although there are two comparison target host fields, the number of comparison target host fields may be three or more. The display host comparison button 690 is a button for transmitting an output condition including two host IDs designated by the comparison target host designation fields 681 and 682 to the data management apparatus 500 in response to the press of the button.

Here, for example, the management terminal 326 receives, from the administrator, a designation of a comparison target host (host1 and host4) in each of the comparison target host designation fields 681 and 682. In FIG. 17, it is assumed that no file is designated in the target file designation field 610. The management terminal 326 receives the operation of pressing the display host comparison button 690 from the administrator. In response to this, the management terminal 326 transmits an output condition including two host IDs designated in the comparison target host designation fields 681 and 682 to the data management apparatus 500. Note that the host ID is an example of the file identification information as described above, the output condition includes the first and second file identification information.

The reception unit 534 receives the output condition including first and second file identification information (host1 and host4) from the management terminal 326 (S201). The second specifying unit 535 specifies the first and second output definitions associated with the first and second file identification information from the storage unit 510 (S202). In the same manner as described above, the acquisition unit 536 acquires a plurality of first management records (S203). The acquisition unit 536 further acquires a plurality of fourth management records corresponding to a combination of any of the attributes included in the second output definition and the second file identification information from the data management DB 520. Then, the generation unit 537 generates the first output information in the same manner as described above (S204). The generation unit 537 connects data in the plurality of fourth management records based on each of the second output definition and the position information in the plurality of fourth management records to generate the fourth output information. The output unit 538 outputs, i.e., transmits, the fourth output information so as to be compared with the first output information (S205).

After that, the management terminal 326 displays the received first and fourth output information on the display apparatus in such a way that the first and fourth output information can be compared with each other. For example, as shown in a display screen 600c of FIG. 17, the output information 630c is displayed. The output information 630c indicates that the record data 631c and 632c corresponding to different hosts (host1 and host4) are displayed in such a way that the record data 631c and 632c can be compared.

As described above, according to this example embodiment, it is possible to make a comparison across files with respect to attributes of the same quality, and it is possible to further diversify the application mode.

### Other Example Embodiments

Although the configuration of the hardware is described in the above example embodiments, the present disclosure is not limited to them. The present disclosure can also be implemented by causing a CPU (Central Processing Unit) to execute a computer program.

In the above examples, the program may be stored and provided to a computer using various types of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Read Only Memory), CD-R, CD-R/W, DVD (Digital Versatile Disc), and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Note that the present disclosure is not limited to the above-described example embodiments, and may be modified as appropriate without departing from the scope thereof. The present disclosure may be implemented by appropriately combining the respective example embodiments.

The whole or part of the embodiments disclosed above can be described as, but not limited to, the following supplementary notes.

### (Supplementary Note A1)

An information processing apparatus comprising:

an extraction unit configured to extract a pair of an attribute and data based on a format corresponding to each collection file from a plurality of collection files collected from an information system and described in a plurality of respective types of the formats;

a first specifying unit configured to specify position information indicating a position in the collection file corresponding to the extracted data; and

a registration unit configured register a management record in a database, the management record including the attribute corresponding to the extracted data, the specified position information, and file identification information about the collection file associated with the extracted data.

### (Supplementary Note A2)

The data management system according to Supplementary note A1, wherein

the registration unit further associates an update date and time of the collection file with the management record and registers them in the database.

### (Supplementary Note A3)

The information processing apparatus according to Supplementary note A1 or A2, further comprising:

a storage unit configured to store an output definition including a plurality of the attributes to be output and the file identification information in association with each other;

a reception unit configured to receive an output condition including first file identification information corresponding to the collection file;

a second specifying unit configured to specify a first output definition associated with the first file identification information from the storage unit;

an acquisition unit configured to acquire a plurality of first management records corresponding to a combination of any of the attributes included in the first output definition and the first file identification information from the database;

a generation unit configured to connect data in the plurality of first management records to generate first output information based on each of the first output definition and the position information in the plurality of first management records; and

an output unit configured to output the first output information.

### (Supplementary Note A4)

The information processing apparatus according to Supplementary note A3 depending on Supplementary note A2, wherein

the output condition further includes two or more pieces of time information to be compared,

the acquisition unit acquires, from the database, a plurality of second management records corresponding to any of the attributes included in the first output definition and any of the two or more pieces of time information included in the output condition,

the generation unit generates second output information so as to compare data associated with the two or more pieces of time information among data in the plurality of second management records, and

the output unit outputs the second output information.

### (Supplementary Note A5)

The information processing apparatus according to Supplementary note 3 or 4, wherein

the output condition further includes an expected value of data in a first attribute,

the acquisition unit acquires a third management record corresponding to the first attribute from the database,

the generation unit generates third output information so as to compare data in the third management record with the expected value, and the output unit outputs the third output information.

### (Supplementary Note A6)

The information processing apparatus according to any one of Supplementary notes A3 to A5, wherein

the output condition further includes second file identification information about a file having the collection file common to the format of the collection file related to the first file identification file,

the second specifying unit further specifies a second output definition associated with the second file identification information from the storage unit,

the acquisition unit further acquires a plurality of fourth management records corresponding to a combination of any of the attributes included in the second output definition and the second file identification information from the database,

the generation unit connects data in the plurality of fourth management records to generate fourth output information based on each of the second output information and the position information in the plurality of fourth management; and

the output unit outputs the fourth output information in such a way that the fourth output information is compared with the first output information.

### (Supplementary Note A7)

The information processing apparatus according to any one of Supplementary notes A3 to A6, wherein the registration unit organizes the attribute extracted by the extraction unit by each collection file from which the attribute is extracted to generate the output definition and registers the file identification information about the collection file from which the attribute is extracted and the generated output definition in the storage unit in association with each other.

### (Supplementary Note A8)

The information processing apparatus according to any one of Supplementary notes A3 to A7, wherein
the generation unit classifies a plurality of records corresponding to the same attribute included in the first output definition among the plurality of first management records into a plurality of different groups based on the position information and generates the output information for each record classified into one of the groups.

### (Supplementary Note A9)

The information processing apparatus according to any one of Supplementary notes A1 to A8, wherein

the plurality of collection files include a configuration file corresponding to a first apparatus included in the information system, and

the file identification information includes identification information about the first apparatus.

### (Supplementary Note A10)

The information processing apparatus according to any one of Supplementary notes A1 to A9, wherein

the plurality of collection files include a command execution result for a second apparatus included in the information system.

### (Supplementary Note A11)

The information processing apparatus according to any one of Supplementary notes A1 to A10, wherein

the plurality of collection files include a plurality of data records including a set of data corresponding to each attribute based on the corresponding format, and

the first specifying unit may include, in the position information, information for identifying a data record to which the extracted data belongs in the corresponding collection file and a positional relation in the data record in the corresponding attribute in the corresponding collection file to specify the position information.

### (Supplementary Note B1)

A data management system comprising:

a collection unit configured to collect a plurality of collection files described in a plurality of respective types of formats from an information system and store the plurality of collection files in a storage apparatus;

an extraction unit configured to extract a pair of an attribute and data based on the format corresponding to each collection file from the plurality of collection files in the storage apparatus;

a first specifying unit configured to specify position information indicating a position in the collection file corresponding to the extracted data; and

a registration unit configured to register a management record in a database, the management record including the attribute corresponding to the extracted data, the specified position information, and file identification information about the collection file associated with the extracted data.

### (Supplementary Note B2)

The data management system according to Supplementary note B1, wherein

the registration unit further associates an update date and time of the collection file with the management record and registers them in the database.

### (Supplementary Note B3)

The data management system according to Supplementary note B1 or B2, further comprising:

a storage unit configured to store an output definition including a plurality of the attributes to be output and the file identification information in association with each other;

a reception unit configured to receive an output condition including first file identification information corresponding to the collection file;

a second specifying unit configured to specify a first output definition associated with the first file identification information from the storage unit;

an acquisition unit configured to acquire a plurality of first management records corresponding to a combination of any of the attributes included in the first output definition and the first file identification information from the database;

a generation unit configured to connect data in the plurality of first management records to generate first output information based on each of the first output definition and the position information in the plurality of first management records; and

an output unit configured to output the first output information.

### (Supplementary Note C1)

A data management method performed by a computer, the data management method comprising:

extracting a pair of an attribute and data based on a format corresponding to each collection file from a plurality of collection files collected from an information system and described in a plurality of respective types of the formats;

specifying position information indicating a position in the collection file corresponding to the extracted data; and

registering a management record in a database, the management record including the attribute corresponding to the extracted data, the specified position information, and file identification information about the collection file associated with the extracted data.

### (Supplementary Note D1)

A data management program for causing a computer to execute: a process of extracting a pair of an attribute and data based on a format corresponding to each collection file from a plurality of collection files collected from an information system and described in a plurality of respective types of the formats;

a process of specifying position information indicating a position in the collection file corresponding to the extracted data; and

a process of registering a management record in a database, the management record including the attribute corresponding to the extracted data, the specified position information, and file identification information about the collection file associated with the extracted data.

Although the present disclosure has been described with reference to the example embodiments, the present disclosure is not limited by the above-described example embodiments.

The configuration and details of the present disclosure may be modified in various ways as will be understood by those skilled in the art within the scope of the invention.

This application is based upon and claims the benefit of priority from Japanese patent application No. 2018-067081, filed on Mar. 30, 2018, the disclosure of which is incorporated herein in its entirety by reference.

### REFERENCE SIGNS LIST

1 INFORMATION PROCESSING APPARATUS
11 EXTRACTION UNIT
12 SPECIFYING UNIT
13 REGISTRATION UNIT
14 DATABASE
141 MANAGEMENT RECORD
1411 DATA
1412 ATTRIBUTE
1413 POSITION INFORMATION
1414 FILE IDENTIFICATION INFORMATION
1000 EXTERNAL SYSTEM
2000 INFORMATION SYSTEM
210 ROUTER
220 AP SERVER
221 CONFIGURATION FILE
222 LOG FILE
230 DB SERVER
231 CONFIGURATION FILE
232 LOG FILE
240 SWITCH
250 GW SERVER
251 CONFIGURATION FILE
252 LOG FILE
260 FW
270 STORAGE APPARATUS
N NETWORK
3000 DATA MANAGEMENT SYSTEM
310 COLLECTION SERVER
311 COLLECTION UNIT
312 COLLECTION DB
313 COLLECTION FILE
320 DATA MANAGEMENT APPARATUS
321 EXTRACTION UNIT
322 SPECIFYING UNIT
323 REGISTRATION UNIT
324 DATA MANAGEMENT DB
325 MANAGEMENT RECORD
326 MANAGEMENT TERMINAL
400 COLLECTION FILE
410 RECORD
4111 PARAMETER NAME
4112 DATA
4121 PARAMETER NAME
4122 DATA
420 RECORD
4n0 RECORD
40 FILE ATTRIBUTE
41 FILE ID
42 TARGET HOST
43 LAST UPDATE DATE AND TIME
400a CONFIGURATION FILE
400b CONFIGURATION FILE
500 DATA MANAGEMENT APPARATUS
510 STORAGE UNIT
511 FORMAT INFORMATION
512 OUTPUT DEFINITION INFORMATION
512a OUTPUT DEFINITION INFORMATION
512b OUTPUT DEFINITION INFORMATION
513 EXPECTED VALUE
514 PROGRAM
520 DATA MANAGEMENT DB
521 MANAGEMENT RECORD
5211 DATA
5212 ATTRIBUTE
5213 POSITION INFORMATION
5214 FILE ID
5215 TARGET HOST
5216 LAST UPDATE DATE AND TIME
522 MANAGEMENT RECORD
52a KEY
52a1 FILE IDENTIFICATION INFORMATION
52a2 POSITION INFORMATION
52b VALUE
530 CONTROL UNIT
531 EXTRACTION UNIT
532 FIRST SPECIFYING UNIT
533 REGISTRATION UNIT
534 RECEPTION UNIT
535 SECOND SPECIFYING UNIT
536 ACQUISITION UNIT
537 GENERATION UNIT
538 OUTPUT UNIT
540 IF UNIT
600 DISPLAY SCREEN
600a DISPLAY SCREEN
600b DISPLAY SCREEN
600c DISPLAY SCREEN
610 TARGET FILE DESIGNATION FIELD
620 DISPLAY BUTTON
630 OUTPUT INFORMATION
631 RECORD DATA
632 RECORD DATA
630a OUTPUT INFORMATION
631a RECORD DATA
632a RECORD DATA
630b OUTPUT INFORMATION
631b RECORD DATA
632b RECORD DATA
633b EXPECTED VALUE
634b EXPECTED VALUE
630c OUTPUT INFORMATION
631c RECORD DATA
632c RECORD DATA
641 COMPARISON TARGET DATE AND TIME DESIGNATION FIELD
642 COMPARISON TARGET DATE AND TIME DESIGNATION FIELD
650 DISPLAY HISTORY COMPARISION BUTTON
660 COMPARISON TARGET ATTRIBUTE DESIGNATION FIELD
670 DISPLAY EXPECTED VALUE COMPARISION BUTTON
681 COMPARISION TARGET HOST DESIGNATION FIELD
682 COMPARISION TARGET HOST DESIGNATION FIELD
690 DISPLAY HOST COMPARISION BUTTON

1. An information processing apparatus comprising:
at least one memory storing instructions, and
at least one processor configured to execute the instructions to:
extract a pair of an attribute and data based on a format corresponding to each collection file from a plurality of collection files collected from an information system and described in a plurality of respective types of the formats;
specify position information indicating a position in the collection file corresponding to the extracted data; and
register a management record in a database, the management record including the attribute corresponding to the extracted data, the specified position information, and file identification information about the collection file associated with the extracted data.

2. The information processing apparatus according to claim 1, wherein the at least one processor further configured to execute the instructions to
associate an update date and time of the collection file with the management record and registers them in the database.

3. The information processing apparatus according to claim 1, further comprising:
storage apparatus storing an output definition including a plurality of the attributes to be output and the file identification information in association with each other; and
wherein the at least one processor further configured to execute the instructions to
receive an output condition including first file identification information corresponding to the collection file;
specify a first output definition associated with the first file identification information from the storage apparatus;
acquire a plurality of first management records corresponding to a combination of any of the attributes included in the first output definition and the first file identification information from the database;
connect data in the plurality of first management records to generate first output information based on each of the first output definition and the position information in the plurality of first management records; and
output the first output information.

4. The information processing apparatus according to claim 3, wherein
the output condition further includes two or more pieces of time information to be compared, and
wherein the at least one processor further configured to execute the instructions to
acquire, from the database, a plurality of second management records corresponding to any of the attributes included in the first output definition and any of the two or more pieces of time information included in the output condition,
generate second output information so as to compare data associated with the two or more pieces of time information among data in the plurality of second management records, and
output the second output information.

5. The information processing apparatus according to claim 3, wherein
the output condition further includes an expected value of data in a first attribute,
wherein the at least one processor further configured to execute the instructions to
acquire a third management record corresponding to the first attribute from the database,
generate third output information so as to compare data in the third management record with the expected value, and
output the third output information.

6. The information processing apparatus according to claim 3, wherein
the output condition further includes second file identification information about a file having the collection file common to the format of the collection file related to the first file identification file,
wherein the at least one processor further configured to execute the instructions to
specify a second output definition associated with the second file identification information from the storage apparatus,
acquire a plurality of fourth management records corresponding to a combination of any of the attributes included in the second output definition and the second file identification information from the database,
connect data in the plurality of fourth management records to generate fourth output information based on each of the second output information and the position information in the plurality of fourth management; and
output the fourth output information in such a way that the fourth output information is compared with the first output information.

7. The information processing apparatus according to claim 3, wherein the at least one processor further configured to execute the instructions to
organize the attribute extracted by the extraction means by each collection file from which the attribute is extracted to generate the output definition and registers the file identification information about the collection file from which the attribute is extracted and the generated output definition in the storage apparatus in association with each other.

8. The information processing apparatus according to claim 3, wherein the at least one processor further configured to execute the instructions to
classify a plurality of records corresponding to the same attribute included in the first output definition among the plurality of first management records into a plurality of different groups based on the position information and generates the output information for each record classified into one of the groups.

9. The information processing apparatus according to claim 1, wherein
the plurality of collection files include a configuration file corresponding to a first apparatus included in the information system, and
the file identification information includes identification information about the first apparatus.

10. The information processing apparatus according to claim 1, wherein
the plurality of collection files include a command execution result for a second apparatus included in the information system.

11. The information processing apparatus according to claim 1, wherein
the plurality of collection files include a plurality of data records including a set of data corresponding to each attribute based on the corresponding format, and
wherein the at least one processor further configured to execute the instructions to
include, in the position information, information for identifying a data record to which the extracted data belongs in the corresponding collection file and a positional relation in the data record in the corresponding attribute in the corresponding collection file to specify the position information.

12-14. (canceled)

15. A data management method performed by a computer, the data management method comprising:
extracting a pair of an attribute and data based on a format corresponding to each collection file from a plurality of collection files collected from an information system and described in a plurality of respective types of the formats;
specifying position information indicating a position in the collection file corresponding to the extracted data; and
registering a management record in a database, the management record including the attribute corresponding to the extracted data, the specified position information, and file identification information about the collection file associated with the extracted data.

16. A non-transitory computer readable medium storing a data management program for causing a computer to execute:
a process of extracting a pair of an attribute and data based on a format corresponding to each collection file from a plurality of collection files collected from an information system and described in a plurality of respective types of the formats;
a process of specifying position information indicating a position in the collection file corresponding to the extracted data; and
a process of registering a management record in a database, the management record including the attribute corresponding to the extracted data, the specified position information, and file identification information about the collection file associated with the extracted data.
